(19) United States
(12) Patent Application Publication
(10) Pub. No.: US 2002/0145277 A1
(43) Pub. Date: Oct. 10, 2002

(54) Vehicle traction enhancer

(76) Inventor: Philip L. Dombey, Grand Rapids, OH (US)

Correspondence Address: Philip L. Dombey, 20202 W. River Rd., Grand Rapids, OH, 43522, US

(21) Appl. No.: 10/055,223

(22) Filed: Jan. 23, 2002

Related U.S. Application Data
(60) Provisional application No. 60/264,608, filed on Jan. 27, 2001.

(51) Int. Cl. B60N 3/12; B60R 11/00; B62D 43/00; B60S 9/00

(52) U.S. Cl. 280/759; 296/37.6; 224/404

(57) ABSTRACT

A low profile, hollow, “H” shaped vessel that, when filled with liquid, greatly enhances traction and handling of rear wheel drive vehicles, by securely adding weight over the drive axel Said vessel (14) is placed in the bed (12) of said vehicle where it straddles the wheel wells (18). Liquid is then added through a fill plug (16) Internal support baffles (22), act to support the entire load surface, while keeping the inertial shift of said liquid to a minimum. Integral tapered ramps (26) ease the loading of cargo, which can be securely tied down to said vessel (14), using the provided tie down slots (24). When said hollow vessel (14) is filled with potable water, the drain plug (20), with integral valve, allows for controlled discharge of said water Optional, model specific, inserts (28) can be snapped into wheel well clearance of said vessel (14), to ensure a custom fit in each vehicle

### BACKGROUND—FIELD OF INVENTION

This invention relates to a hollow, low profile, “H” shaped vessel which when placed in the bed of a pick-up truck or similar vehicle, and filled with liquid, greatly enhances the traction and handling of said vehicle in adverse driving conditions

### BACKGROUND—DESCRIPTION OF PRIOR ART

No prior art methods were found for the enhancement of traction, by addition of mass over the rear drive axle, in a modern pick-up truck or van. All methods currently used suffer from several major drawbacks, in that they

(a) Require using bulky, heavy objects that displace valuable cargo space

(b) Require the use of heavy objects that can shift, and mar the bed of said vehicle

(c) Require the use of heavy objects that can shift in the bed, rapidly changing center of mass, and thus the handling characteristics of said vehicle

(d) Require the use of bags filled with a granular substance that will contaminate cargo area when said bags inevitably become torn or break open.

### OBJECTS AND ADVANTAGES

Accordingly, several objects and advantages of the present invention are

(a) to provide a means of continuous traction enhancement through a wide range of severe driving conditions;

(b) to provide a means of improved handling due to proper load distribution over bed surface,

(c) to provide a device with internal support pillars acting as baffles to minimize load shifting,

(d) to provide a cushioned, shock absorbing bed with integral tie down slots for transport of fragile cargo;

(e) to provide a rugged, easy to store, inexpensive and easily manufactured accessory that addresses the negative issues of traction and handling inherent in rear wheel drive vehicles,

(f) to provide a sturdy vessel for transport of potable water to remote sites,

Further objects and advantages will become apparent from a consideration of the ensuing description and drawings.

### SUMMARY, RAMIFICATIONS AND SCOPE

Accordingly, the reader will see that this invention will be beneficial to all people who drive small to medium sized rear wheel drive vehicles on adverse road conditions

The main object of this invention is to provide the user of said vehicles with a means of adding more than two hundred pounds of mass, over the drive axle, thus greatly improving traction and handling characteristics Furthermore, the vehicle traction enhancer has some additional advantages in that its simple “H” shape assures a snug fit in vehicle bed and eliminates scratches and dents caused by a shifting load

it has integral and easily accessible fill and drain plugs with fill plug being situated to allow for expansion of water at phase transition of water.

it is easy to stack and store

it is environmentally safe and, if ruptured, will not contaminate cargo bed or surroundings with anything more than water

it allows for ease of cargo loading due to taper on fore and aft ends

Although the description above contains many specifcities, these should not be construed as limiting the scope of the invention but as merely providing illustrations of the present preferred embodiment of this invention

### DRAWING FIGURES

FIG. 1 shows the front, top and end view of this invention

FIG. 2 shows said invention straddling the wheel wells in the vehicle bed.

FIG. 3 shows said invention being cross sectioned at views “AA” and “BB”

FIG. 4 is an enlarged cross sectional view, showing internal support baffles.

FIG. 5 shows optional, model specific, insert with enlarged cross sectional view

FIG. 6 shows said insert installed in said invention

### REFERENCE NUMERALS IN DRAWINGS

| | |
|---|---|
| 12 vehicle bed | 22 support baffles |
| 14 invention | 24 tie down slots |
| 16 fill plug | 26 tapered ramps |
| 18 vehicle wheel well | 28 model specific inserts |
| 20 drain plug | |

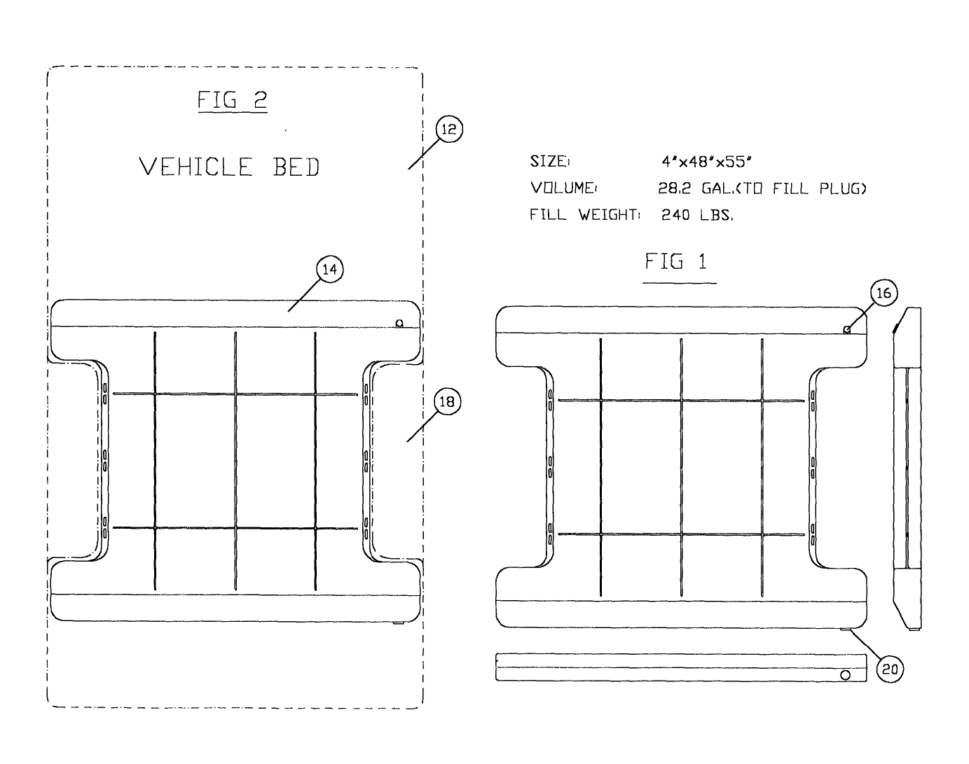

Description—FIGS. 1-6

A typical embodiment of the vehicle traction enhancer is shown in the front, top and end view FIG. 1

This invention is comprised of a single, hollow “H” shaped vessel with resealable fill and drain plugs as well as integral tie down slots

This invention 14 FIG. 1, when filled with liquid at a fill plug 16, that is located below top surface of said invention, to allow for proper fill height as liquid expands at phase transition A drain plug 20 is located for easy access and is fitted with a valve that can also be used as a spigot

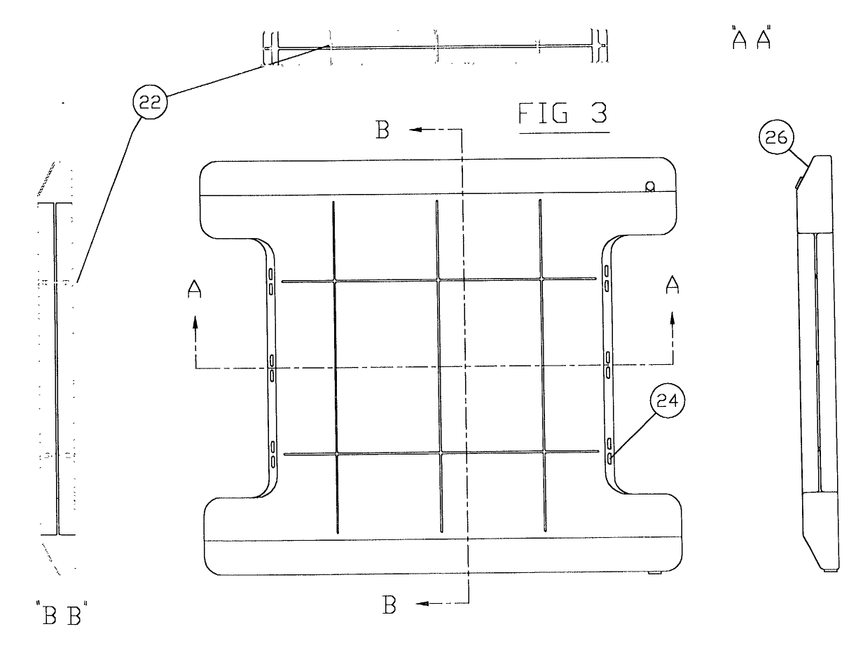

Said invention as shown in the vehicle bed 12 FIG. 2, snugly straddling the wheel wells 18 of said vehicle.

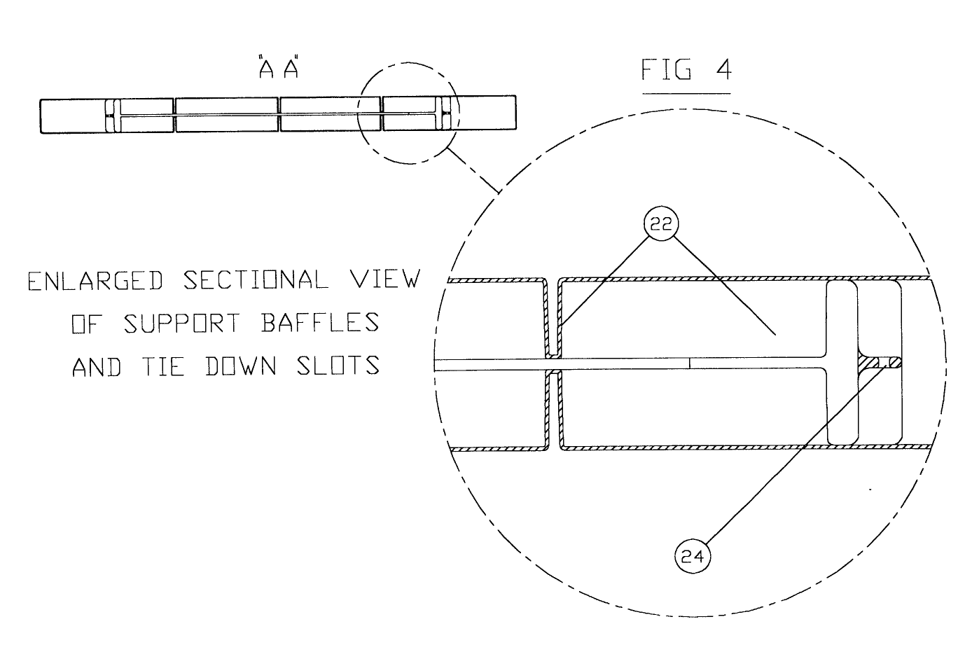

Support baffles 22 FIGS. 3 and 4 are dual purpose, in that they support the load surface of said invention, while baffling the effects of shifting liquid Tie down slots 24 are provided as a means of fastening cargo and tapered ramps 26, allow for ease of loading and unloading of said cargo

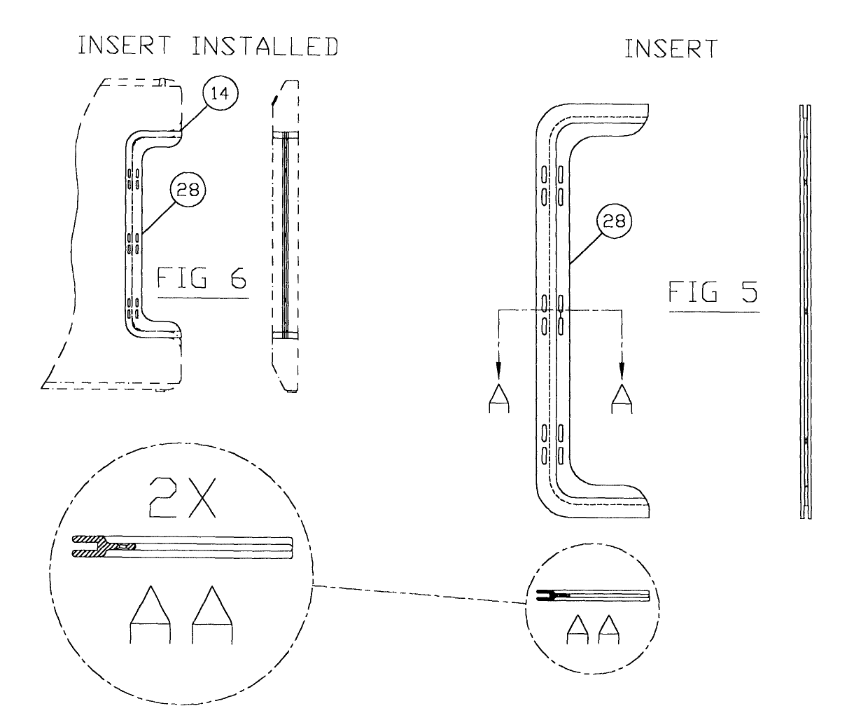

Model specific inserts 28 FIG. 5 may be snapped into place on the invention 14, as shown in FIG. 6 to assure a snug fit in individual vehicle models

Operation—FIGS. 1,2

The manner of using the vehicle traction enhancer is simple Namely, one first places this invention 14 FIG. 1 in vehicle bed 12 FIG. 2, straddling the wheel wells 18 and fills with liquid, at a level determined by the vertical placement of the fill plug 16 FIG. 1 When said invention is used as a water vessel, water is gravitationally fed through spigot in drain plug 20

I claim

1. A vehicle traction enhancing device, shaped to straddle vehicle wheel wells comprising: a hollow, liquid filled interior supported by ribs running parallel to one another with said ribs acting as liquid baffles, a fill plug located for controlled fill height, a drain plug with integral valve that allows for a controlled discharge of said liquid, and through slots used for securing cargo with fastening devices
